(19) United States
(12) Patent Application Publication
(10) Pub. No.: US 2003/0154984 A1
(43) Pub. Date: Aug. 21, 2003

(54) Disposable breathing mask

(76) Inventor: Mark Anthony John Fernandes, England (GB)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/220,131

(22) PCT Filed: Feb. 28, 2001
(86) PCT No.: PCT/GB01/00862

(30) Foreign Application Priority Data
Mar. 9, 2000 (GB) 0005723.2

(51) Int. Cl. A62B 7/10; A62B 18/08

(52) U.S. Cl. 128/205.27; 128/206.12; 128/206.13

(57) ABSTRACT

A disposable breathing mask (1) comprising side walls (4, 5) and bottom walls (6, 7) made of multilayer filter material. The mask is attached to a user's head (2) by means of a strap (3) attached to attachment areas (25, 26). Joining the attachment points (25, 26) is a rib (27) which extends over the user's nose. The attachment points (25, 26) and rib (27) together form an exo-skeleton which maintains the positional stability of the strap mounting areas during donning of the mask. Arms (31, 32) extend laterally away from the rib (27) and are arranged such as to apply mild pressure to the side walls (4, 5) in the region of the user's nose so as to ensure contact between the filter material and the user's nose.

This invention relates to a disposable breathing mask.

Breathing masks are worn to protect a user who has to enter a contaminated environment. Various types of mask are available, providing different amounts of protection according to the level and type of contamination expected. Disposable breathing masks are generally used in areas of mild to medium contamination. Such masks are currently available in two varieties: a first, made of a semi-rigid filter material is formed into a generally cup-shape and is equipped with straps whereby it may be fitted securely over the nose and mouth; and a second, made of a flexible filter material which is folded into a shape which enables it to cover the nose and mouth, and is equipped with straps to enable it to be drawn against the face during use.

The present invention is concerned particularly with masks of the second type. Such masks are usually made from a multilayer filter material in which the various layers provide the different properties required of the fabric as a whole, such as structural integrity, filtration, resistance to wetting and comfort. Various different materials are available commercially and are chosen according to the expected usage of the mask, for example general purpose or specially designed for filtration of particulates or vapours. Typically, the filter materials may be made of plastics such as melt blown polypropylene.

In use, the user breathes through the filter material and is thereby given protection from the environment. In the simplest form of mask, both inhalation and exhalation take place through the filter material. However, a more sophisticated version is available in which a simple exhale valve, for example of the flap type, is fitted to cater for exhalation. This prevents a build-up of moist air against the user's face, and makes the mask more comfortable to wear for extended periods.

The masks are disposable in the sense that, once the filter material becomes contaminated and/or ceases to function, the mask is disposed of; it is not possible to renew the filter material. However, it is possible for the mask to be used several times before this happens and, being made of flexible material, the mask can conveniently be folded up and slipped into a pocket between uses.

In a first aspect of the present invention there is provided a disposable breathing mask comprising one or more sheets of filter material and mounting points attached at spaced positions to said filter material for attachment of a strap or straps whereby the mask may be attached to a user's head, said mask being characterised in that said sheet or sheets are formed into left and right side walls and a bottom wall, which walls are joined at their edges to form a cup-shape having a rim suitable to cover the user's nose and mouth, which rim has a shape which is wider at the bottom that at the top.

The wider bottom part of the rim is intended to cover the user's chin, whereas the narrower top part of the rim is intended to cover the user's nose. Thus, in the unfolded position of the mask, the rim has a generally triangular shape, but the bottom edge of such a triangular shape may be split into two, as will be explained in more detail below, to form a line containing a shallow angle—thus the rim starts to become more of a diamond shape.

In an embodiment each of the three walls is of an approximately triangular or truncated triangular (i.e. trapezium) shape and one of the three edges of each triangle forms a portion of the rim of the cup-shape, while the other edges adjoin adjacent walls to form, when unfolded for use, a pyramidal structure with a triangular base. In the preferred embodiment, the bottom wall is itself split into a left bottom wall and a right bottom wall, both triangular in shape, to product a 4 walled mask which, when unfolded for use, has a pyramidal structure with a 4-sided base.

The junctions between adjacent walls may be formed by welding, stitching or similar joins to adjacent edges of the sheet filter material or may be formed simply by a fold in a single sheet of filter material which forms both walls. Thus, each wall, be there 3 or 4 walls, may be formed from a separate sheet of filter material which are all attached together at their edges. However it is preferred to utilise fewer sheets of filter material by making multiple walls out of a single sheet, the junctions between adjacent walls being formed, as mentioned above, by a combination of folds and welds or similar. In the preferred embodiment, all four walls are fabricated from a single sheet of material, as will be described in more detail hereinafter.

Preferably the mask is approximately symmetrical about a vertical axis. In the three-walled embodiment, the vertical axis extends through the apex (top) of the equilateral triangular-shaped rim of the mask and through the approximate centre of the opposite (bottom) side, so as to give an opening which is wider at the bottom to accommodate the user's jaw, and narrower at the top to close securely around the user's nose. In the preferred four-walled embodiment, the bottom wall is split into two approximately equal triangular walls such that the junction between these two walls passes through the axis, and the rim is more of a diamond shape.

From the point of view of functionality when in use, the splitting of the bottom wall into left and right bottom walls about the vertical axis of symmetry does not make much difference. The advantage, however, of splitting the bottom wall in this way is that the mask becomes much easier to fold up into a substantially flat shape when not in use. There are two possible folded up positions—a first, preferred, position in which the folded bottom walls are tucked within and wholly enclosed by the two side walls and a second position in which the bottom walls are folded outwards so as to extend beyond the side walls. The two folded positions will be described in more detail below.

It has already been mentioned that the opening presented by the mask, when unfolded for use, is narrow at the top to fit over the user's nose. This top part of the rim, of course, forms the apex of the triangular shaped rim and is thus formed by the junction between the two side walls of the mask. In order to ensure that the mask follows the contours of the nose shape and provides a good seal, it is preferred not to make this junction too sharp. This can be achieved simply by forming the two side walls out of the same sheet of filter material and not providing a specific score line between the upper edges of these walls, but allow the fold to form naturally. Other junctions between walls, however, are preferably formed either by edge-to-edge joints, or specific “score” lines to define a line of weakness about which the material will preferentially fold when being moved from its folded state to its unfolded state, or vice versa. There are various known ways of providing such lines of preferential folding in a fabric material such as is used for the filter material. For example a line of stitching, or clamping between heated elements to give a live hinge effect. Where a specific join is formed, for example by stitching or welding, between adjacent edges, an inherent line of preferential folding is formed.

One disadvantage of known masks is that handling of the straps to fit the mask to the user's head often distorts the shape of the mask, which after all is only made of a fabric material, to an extent that makes it difficult to fit. Careful arrangement of folds and joins can reduce this problem, but the present invention seeks to overcome the problem by providing a more rigid connection between the strap mounting points.

Thus, according to a second aspect of the invention, there is provided a disposable breathing mask comprising one or more sheets of filter material and mounting points attached at spaced positions to said filter material for attachment of a strap or straps whereby the mask may be attached to a user's head, said mask being characterised in that said mounting points are joined by a rib or ribs of semi-rigid plastics material.

In an embodiment, the rib or ribs, and preferably the mounting points as well, are mounted externally of the filter material, thus forming an exo-skeleton which maintains the structural integrity of the mask, particularly whilst donning the mask.

Generally speaking there will be one mounting point on the left side of the mask and one on the right side of the mask. However, it is possible for multiple mounting points to be provided on each side to cater for more sophisticated strap arrangements. It is envisaged that the exo-skeleton will join all such mounting points on each side and will in addition join the left and right hand side mounting points. In doing this latter, the rib forming the exo-skeleton can be arranged to arch over the nose area and respective extensions can be formed, which extensions extend towards the user's nose to provide a “nose pinch” to ensure a good seal between the filter fabric and the nose. In prior masks, this nose pinch feature has often been realised by means of a thin strip of deformable material, such as aluminium, which is attached to or within the filter material. The strip is squeezed and shaped by the user, once the mask has been fitted, to provide a good seal over the nose. The extensions, if properly designed, can take the place of such a deformable strip or can be used in conjunction with a deformable strip in order to provide the necessary nose pinch effect.

Whilst the concept of an exo-skeleton can be applied to any mask made out of a fabric-based filter material, it may be particularly advantageously fitted to the disposable breathing mask described according to the first aspect of the present invention. In this case, the left and right mounting points are respectively fitted to the left and right walls of the sheet of material making up the mask. The rib forming the main part of the exo-skeleton may then extend over the joint between the left and right walls which joint, as has already been mentioned, is preferably formed as a natural fold between different sections of a single sheet of filter material.

That part of the rib which extends over the nose is preferably made thinner and/or split to weaken its resistance to bending in order not to inhibit too much the ability of the mask to fold up neatly, whilst at the same time providing a degree of torsional rigidity to thus maintain the left and right mounting points in approximate alignment with one another and also allow the “nose pinch” extensions, if fitted, to provide a reasonable pressure to seal the fabric against the user's nose.

As with all breathing masks, it is important that the mask not only fits the face properly but is also drawn against the face with a sufficient pressure to ensure a good seal with reasonable comfort for the user. Usually for this purpose elasticated straps are used which are usually of a fixed length (buckles increase complication and cost). Different head sizes and shapes are intended to be accommodated by the elasticity of the strap.

However, relying solely on the elasticity of the strap does not provide the right balance of sealing and comfort for all head sizes. For this reason, and according to a third aspect of the present invention, there is provided a disposable breathing mask comprising a facepiece made of filter material and intended to fit over the nose and mouth of a user, and mounting points attached at spaced positions to said facepiece for attachment of a strap or straps whereby the mask may be attached to a user's head, said mask being characterised in that one or both of said strap mounting points are provided with a strap length adjustment means in the form of a plurality of spaced apart looping means into a selected one of which the strap can be looped, said looping means being so positioned with respect to one another as to provide an adjustable strap length according to which looping means the strap is looped into.

Preferably the looping means are associated with at least one strap guide means whereby the strap is guided over the looping means. Thus, if the strap is continuous through the mounting point, the strap can be arranged to pass from one guide means to a second guide means spaced from the first via the looping means which is situated approximately in between the guide means. In the event that the strap is not continuous through the mounting point, one of the guide means may be replaced by a strap attachment point to which one end of the strap is attached. In this latter case, the strap extends from the strap attachment point, over the looping means and through the remaining guide means. A similar arrangement could be in place on the other end of the strap, or the strap might simply have a fixed termination at the other end. In either case, it will be seen that the effective length of the strap can be adjusted by looping the strap across a selected looping means at one or both mounting points. This enables the strap to be adjusted for the right balance between comfort and sealing.

Each looping means may comprise a simple hook, opening in a direction away from the head. A plurality of such hooks spaced apart in a line away from the head will allow strap adjustment in the manner described.

The strap itself may be continuous—i.e. made out of a single loop of elasticated material—or non-continuous.

If an exo-skeleton is fitted in the manner described above, the strap length adjustment means may be attached to form an integral part of the rib structure forming the exo-skeleton.

In order that the invention may be better understood, an embodiment thereof will now be described by way of example only and with reference to the accompanying drawings in which:

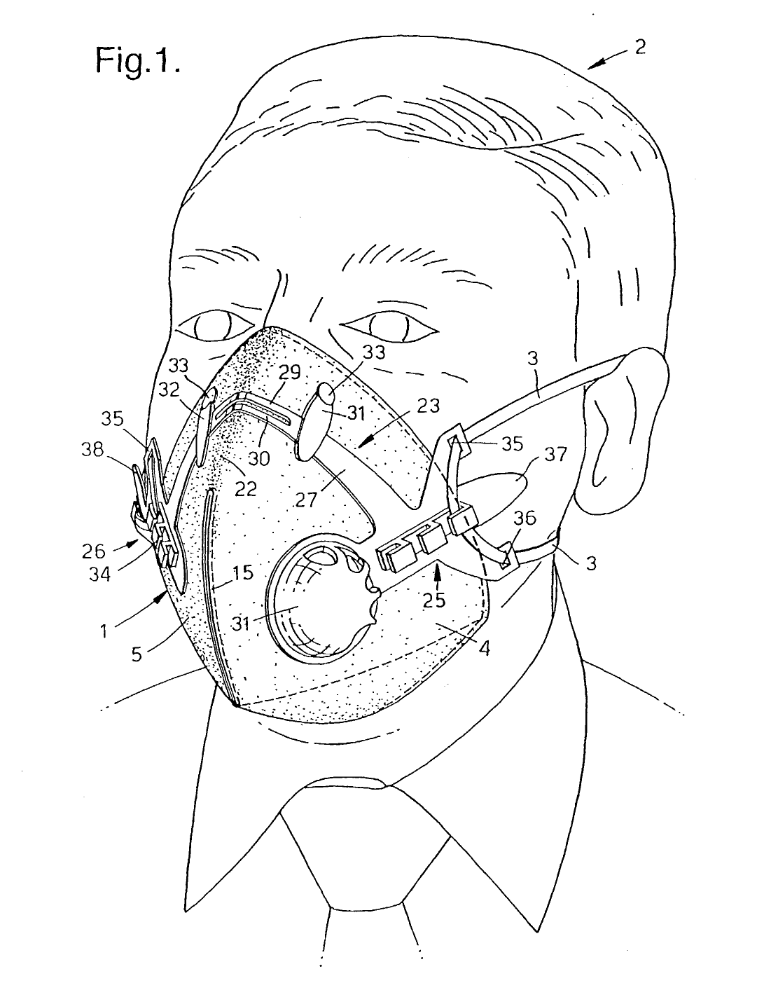

FIG. 1 is a perspective front view of a disposable breathing mask according to the present invention;

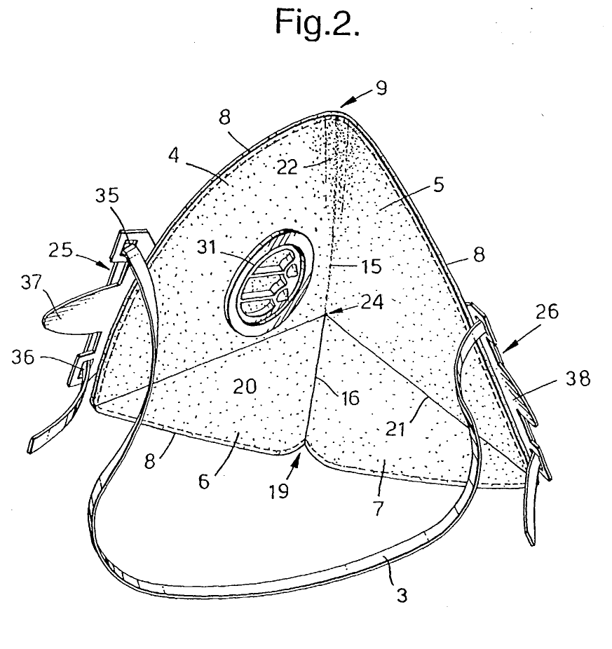

FIG. 2 is a perspective inside view of the mask of FIG. 1, shown in the unfolded position;

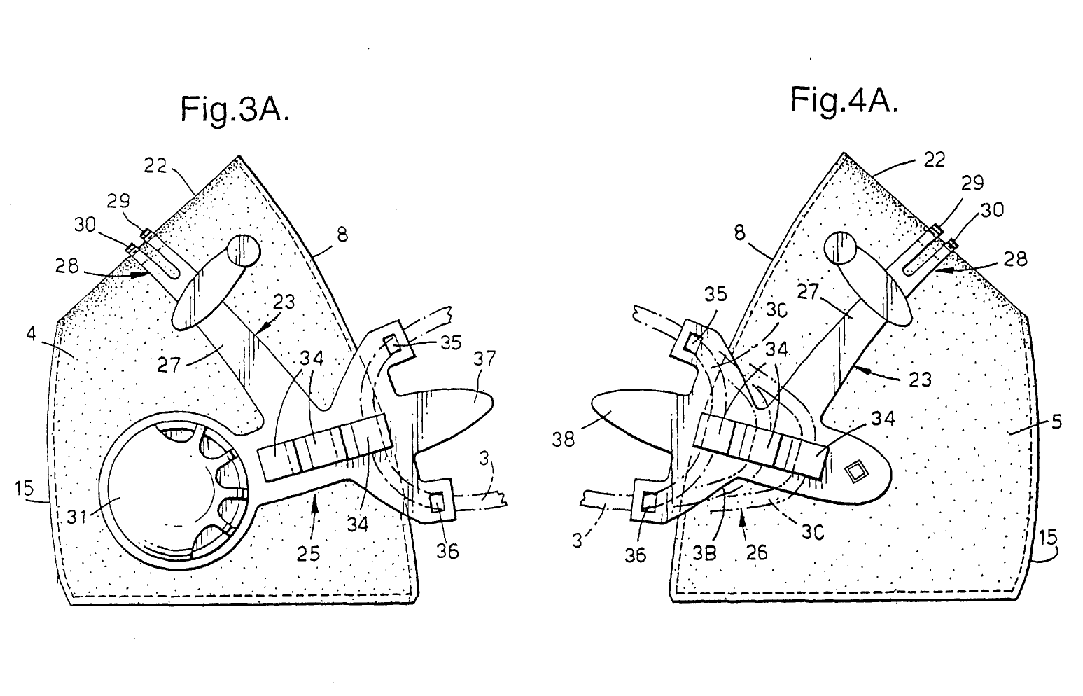

FIGS. 3A, B and 4A, B are left and right side views respectively of the mask of FIG. 1;

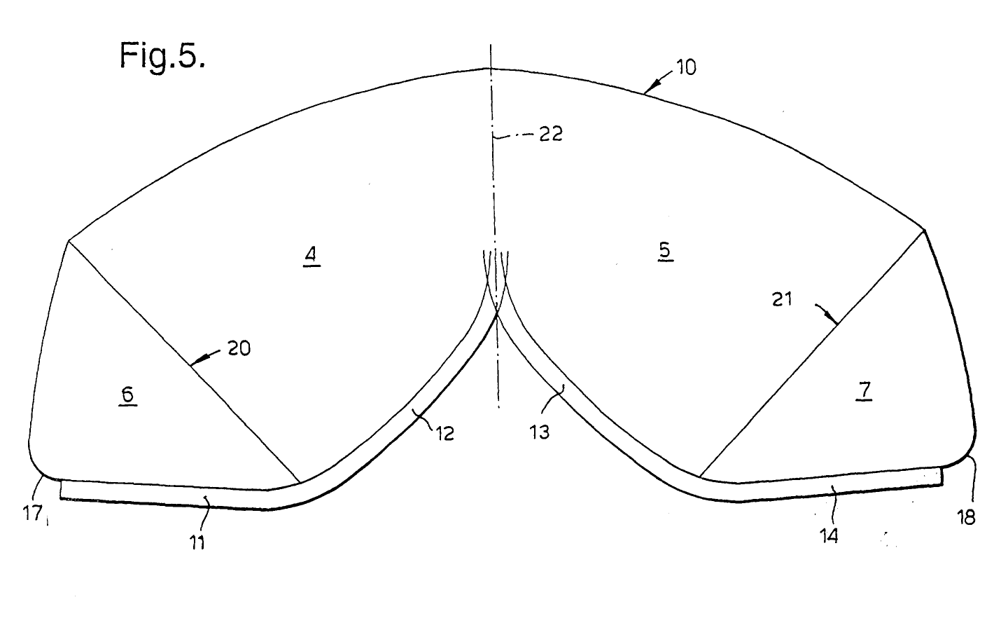

FIG. 5 is a drawing of the blank used to make the filter fabric part of the mask of FIG. 1; and

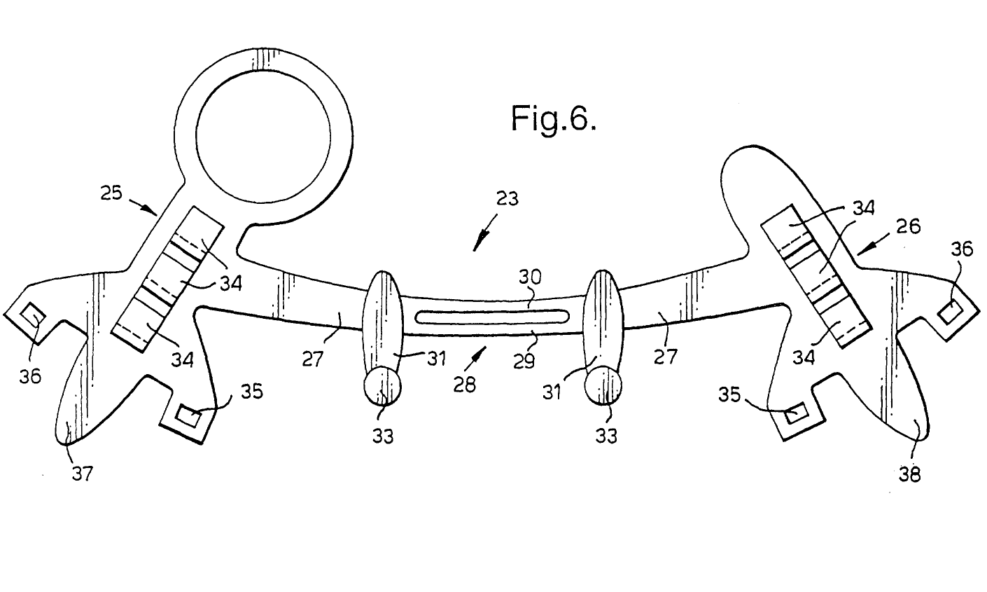

FIG. 6 is a drawing of the exo-skeleton used in the mask of FIG. 1, shown in a folded-flat position.

Referring to the drawings, the mask, when unfolded for use, comprises an approximately cup-shaped facepiece made up of a single sheet of filter fabric through which air can be inhaled and exhaled. The filter fabric is a commercially-available multilayer fabric chosen for the correct combination of mechanical and filter characteristics.

FIG. 1 illustrates the mask, shown generally under reference 1, being worn by a user 2. As can be seen, the mask covers the mouth and nose of the user, and an elasticated strap 3 secures the mask 1 to the user's head.

The mask is made by forming the filter fabric into four walls: left and right side walls 4,5 and left and right bottom walls 6,7. Roughly speaking, the side walls cover the nose and cheek of the user, whilst the bottom walls cover the underside of the chin. Each of the walls are approximately triangular in shape, but the side walls are slightly truncated to form a shape more like a trapezium. FIG. 2 shows the inside of the mask, in the partly unfolded position, and in which the rim 8 of the cup-shape which forms the facepiece has the approximate shape of an equilateral triangle, having an apex 9. The facepiece is approximately symmetrical about a vertical axis which passes through the apex 9 and the middle of the opposite (bottom) side of the aforesaid equilateral triangle, at the point at which the join between the left and right bottom walls 6,7 meets the bottom edge of the rim 8. As the mask is unfolded beyond the position shown in FIG. 2, the shape of the rim becomes an approximate diamond shape and it is when in this latter position that the mask is placed over the face. The process of unfolding will be described in more detail below.

As mentioned, the facepiece is fabricated from a single sheet of filter material. The shape of this is shown in FIG. 5. The areas of the blank shown in FIG. 5 are identified by appropriate reference numerals to the walls which they will become in the finished product. The top edge 10 in the drawing becomes the rim 8 of the cup-shaped facepiece. The doubled lines 11, 12, 13 and 14 represent edges which are to be attached by stitching or welding or the like to form the initially flat blank into an approximately cup-shape. The edges 12 and 13 are joined together to form the join 15 in the finished facepiece; the edges 11 and 14 are joined together to form the join 16 in the finished facepiece. It will be noticed that the lower left and right hand corners 17,18 of the blank are rounded, this being to form an indentation 19 in the approximate centre of the bottom edge of the rim 8 of the finished facepiece (see FIG. 2). This is intended to reduce discomfort which might be caused by the stretching of the bottom edge across the user's windpipe/adam's apple.

The junction between the side walls and bottom walls on each side is formed by creating respective left and right lines of weakness in the blank, before folding. These are shown under references 20 and 21 respectively. It will be noted that the joins 15 and 16, and the lines of weakness 20 and 21 all converge at a common point 24. These joins, and lines of weakness define lines of preferential bending when the facepiece is handled, and allow the facepiece to be readily folded up after use, as will be explained in more detail below.

It will be noted that the top join 22 between the side walls 4 and 5 is not formed with a line of weakness, but is left to fold naturally. The reason for this is that a sharp corner at this point is felt to be undesirable since it might impair the sealing of the filter fabric to the user's nose.

The attachment points for the strap 3 are formed on an exo-skeleton 23 made of semi-rigid plastics material such as polypropylene or polyethylene. The exo-skeleton, which is illustrated in flat form in FIG. 6 comprises left and right strap attachment/adjustment areas 25,26 and, joining these, a rib 27 which extends over the join 22 in the facepiece. The centre part 28 of rib 27 is split into two sections 29,30, and made of thinner material to increase flexibility in the critical area over the nose, but as much as possible retain torsional rigidity to maintain the structural integrity of the mask, particularly whilst it is being taken on and off.

The exo-skeleton is attached to the filter fabric either continuously or at spaced points by stitching or welding or any other suitable method. An extension to the exo-skeleton either on the left side (as shown) or right side or both sides mounts an optional exhale valve 31. As explained above, these are fitted to reduce build-up of moist air under the mask and can make the mask more acceptable to wear for long periods. The construction of such exhale valves is well known and will not be described.

Extending laterally to the rib 27 are a pair of arms 31,32 which are positioned at respective opposite ends of the central part 28 of the rib. The arms 31,32 extend in a direction towards the rim 8 of the mask in the area of the side walls 4,5 respectively. The purpose of these arms is to apply mild pressure to the respective walls 4,5 where they cover the sides of the user's nose to ensure contact between the surface of the nose, and the filter fabric. To this end, the end 33 of each of the arms 31,32 may be provided on its underside with a pad (not shown) which extends beyond the general plane of the rib 27 in the direction of the fabric surface; alternatively, or in addition, the arms may be arranged to be angled at a shallow angle in a direction inwards towards the nose.

The arms 31,32 may be formed separately from the remainder of the exo-skeleton but conveniently they may be formed integrally with the exo-skeleton. In addition a strip (not shown) of deformable material such as aluminium may be fitted to the exo-skeleton in the region where the mask extends over the user's nose. This strip is used in conjunction with the arms 31,32 to effect sealing of the filter material over the nose, whilst at the same time maintaining reasonable comfort. The strip can be fitted in various ways: an example would be that the strip could extend between the ends 33 of the respective arms 31,32 in a direction parallel to the sections 29,30 of the rib 27.

Each of the strap attachment/adjustment areas 25,26 comprises three hooks 34 which are spaced apart in a direction away from the rim 8 of the mask. These hooks are used, in conjunction with guide means in the form of a pair of spaced slots 35,36 to allow adjustment of the strap 3. In the embodiment illustrated, the strap 3 takes the form of a continuous loop of elasticated material. The elasticated nature of the strap gives a certain degree of flexibility in dealing with different head sizes, but not much. The strap adjustment means shown is intended to effectively vary the length of strap available to go around the head, thus giving much greater flexibility in the sizes of head which can be comfortably accommodated.

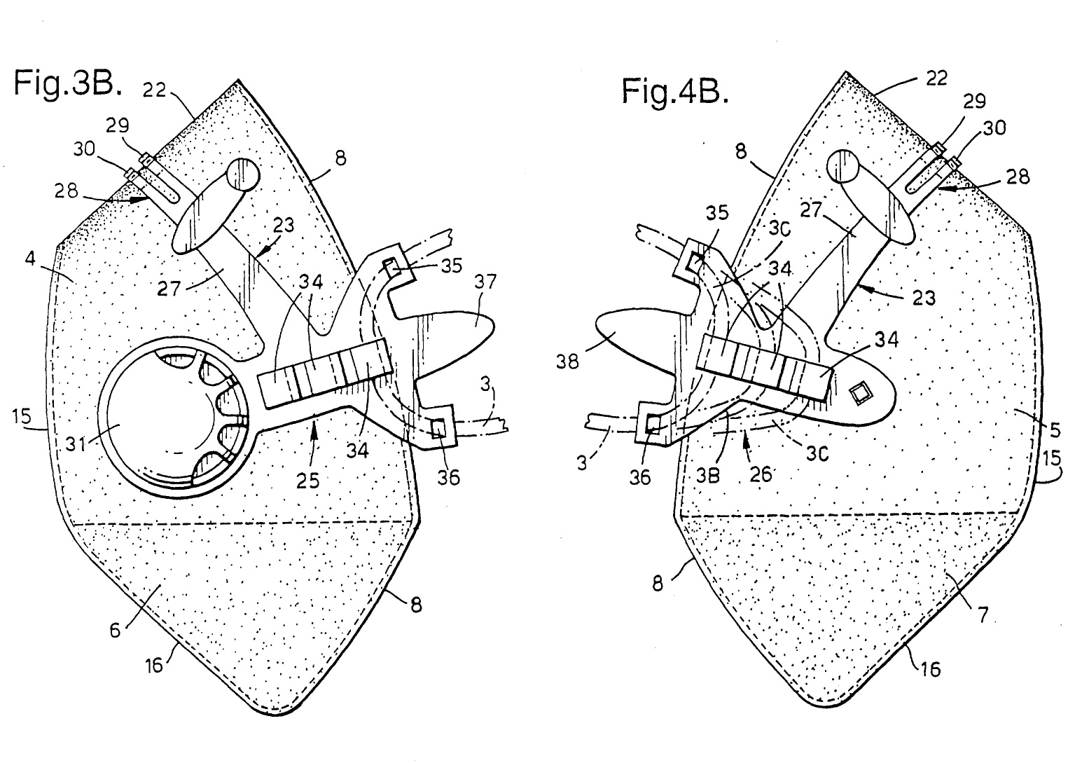

The alternative strap positions are shown doffed in FIGS. 4A and 4B under references 3A, 3B and 3C. It will be seen that position 3C gives the tightest strap for smaller heads.

In the event that the strap is not continuous, then a similar adjustment function can be achieved by terminating the strap at the positions, say, of the slots 35 on each side then looping the strap over one of the adjacent set of hooks 34, through the slot 36 and round the head to the other side.

One difficulty with many existing designs of mask is that it is often difficult to open the mask and get it correctly positioned on the head. This operation might seem relatively easy in a well-lit room, but in a hazardous environment, where light levels might be poor and hands restricted by thick gloves, or the necessity to hold something for support, great difficulty can be experienced. The mask of the present invention is designed to be able to be unfolded and donned easily.

There are two possible folded positions for the mask. In the preferred folded position, shown in side elevation in FIG. 3A (left side) and FIG. 4A (right side), the left and right bottom walls 6,7 fold inwards about join 16 as the mask is folded. At the same time the left and right side walls 4,5 fold about the join 15 to completely enclose the bottom walls in the fully folded position. The bottom walls are thus hidden. In the alternative position, shown in side elevation in FIG. 3B (left side) and FIG. 4B (right side), the bottom walls 6,7 fold outwards about the join 16, and are thus visible.

In both cases, all of the walls 4, 5, 6 and 7 are parallel with one another in the folded position. In this position it will be seen that the mask will readily slip in the pocket and is available for re-use. Notice also that, in moving from the unfolded position to the folded position and vice versa, no potentially soiled part of the mask is moved against a clean part of the mask, thus spoiling the mask prematurely and preventing its further use.

The difference between the two methods of folding the mask is that, in the preferred method, the folded mask, although somewhat fatter, being 4 layers of filter material thick, is dimensionally smaller in side elevation and is thus able to be stored in the pocket more easily (see FIGS. 3A and 4A). The alternative method of folding results in a thinner mask (2 layers of filter material only) but one which is significantly larger in side elevation, as is clearly seen in FIGS. 3B and 4B.

In order to assist in the unfolding process, the strap attachment/adjustment areas 25,26 of the exo-skeleton are provided with respective wings 37,38 which protrude beyond the rim 8 of the mask and may be grasped, even when wearing thick gloves, to easily unfold the mask and enable it to be donned.

Starting with the preferred folded position, unfolding proceeds by grasping the wings 37,38 and pulling them apart. This causes the side walls 4,5 to unfold outwardly and the bottom walls to unfold from within the confines of the side walls, through the position illustrated in FIG. 2 and finally to a position in which the rim 8 is of an approximately diamond-shape, defined by the outward-facing edges of the walls 4, 5, 6 and 7. At this point, the mask can be said to be fully open and can be placed over the nose and mouth, whilst still continuing to grasp the wings 37,38. At a suitable point in this process, the user lets go of the wings so as to arrange the strap 3 behind the head.

If, without attempting to don the mask, the wings are expanded beyond the fully open position, it will be noticed that the top and bottom of the diamond-shaped rim, when seen in the direction of FIG. 2, start to be drawn towards one another—in other words, they cease to move apart, and instead start to draw together. In practice the user will, by this time, be placing the mask over his or her face, as explained above; however, this demonstrates that pressure on the strap due to being expanded around the head will actually act to draw the upper and lower extremities of the mask towards one another to thus assist in the sealing of the mask in the nose and chin areas.

1. A disposable breathing mask comprising one or more sheets of filter material and mounting points attached at spaced positions to said filter material for attachment of a strap or straps whereby the mask may be attached to a user's head, said mask being characterised in that said sheet or sheets are formed into left and right side walls and a bottom wall, which walls are joined at their edges to form a cup-shape having a rim suitable to cover the user's nose and mouth, which rim has a shape which is wider at the bottom that at the top.

2. A mask as claimed in claim 1 wherein each of the side walls is of an approximately trapezium shape and the bottom wall is of a triangular shape.

3. A mask as claimed in either one of claims 1 or 2 wherein the bottom wall is split into a left bottom wall and a right bottom wall with a foldable junction between said left and right bottom walls.

4. A mask as claimed in claim 3 wherein each of the left and right bottom walls are of an approximately triangular shape and are of approximately the same size.

5. A mask as claimed in any one of the preceding claims wherein the junctions between adjacent walls are foldable.

6. A mask as claimed in claim 5 wherein at least some of the junctions are formed by welding.

7. A mask as claimed in either one of claims 5 or 6 wherein at least some of the junctions are formed by stitching.

8. A mask as claimed in any one of claims 5 to 7 wherein at least some of the junctions are formed by a single fold in a single sheet of said filter material.

9. A mask as claimed in claim 8 wherein at least the junction between the side walls intended to extend over the user's nose when in use is of the type formed by a simple fold in a single sheet of said filter material.

10. A mask as claimed in any one of claims 1 to 9 wherein said strap mounting points are fitted with respective wings (37,38) which protrude beyond the rim of the mask so that they can be grasped to unfold the mask.

11. A mask as claimed in any one of the preceding claims wherein said mounting points are joined by a rib or ribs of semi-rigid plastics material.

12. A disposable breathing mask comprising one or more sheets of filter material and mounting points attached at spaced positions to said filter material for attachment of a strap or straps whereby the mask may be attached to a user's head, said mask being characterised in that said mounting points are joined by a rib or ribs of semi-rigid plastics material.

13. A mask as claimed in either one of claims 11 or 12 wherein the rib or ribs are mounted externally of the filter material.

14. A mask as claimed in any one of claims 11, 12 or 13 wherein the rib or ribs are arranged so that, when the mask is in position on a user's head, the rib or ribs extend over the user's nose, and wherein means mounted on the rib or ribs are provided to lightly pinch the user's nose to provide a good seal between the filter material and the nose.

15. A mask as claimed in claim 14 wherein said means comprises a pair of arms extending laterally of the rib or ribs in a direction towards the rim of the mask, said arms being positioned so as to apply mild pressure against the walls of the mask where they cover the sides of the user's nose.

16. A mask as claimed in any one of claims 11 to 15 wherein that part of the rib or ribs which extend over the user's nose has a weakened resistance to bending to allow the mask to be folded.

17. A mask as claimed in any one of the preceding claims wherein one or both of said strap mounting points are provided with a strap length adjustment means in the form of a plurality of spaced apart looping means into a selected one of which the strap can be looped, said looping means being so positioned with respect to one another as to provide an adjustable strap length according to which looping means the strap is looped into.

18. A disposable breathing mask comprising a facepiece made of filter material and intended to fit over the nose and mouth of a user, and mounting points attached at spaced positions to said facepiece for attachment of a strap or straps whereby the mask may be attached to a user's head, said mask being characterised in that one or both of said strap mounting points are provided with a strap length adjustment means in the form of a plurality of spaced apart looping means into a selected one of which the strap can be looped, said looping means being so positioned with respect to one another as to provide an adjustable strap length according to which looping means the strap is looped into.

19. A mask as claimed in either one of claims 17 or 18 wherein the looping means are associated with at least one strap guide means whereby the strap is guided over the looping means.

20. A mask as claimed in claim 19 wherein each strap mounting point is provided with two spaced guide means, with the looping means arranged between the spaced guide means in such a way that a strap, passing from one guide means to the other, may be adjusted in effective length by being passed over different looping means.

21. A mask as claimed in claim 19 wherein each strap mounting point is provided with a guide means and a strap attachment point spaced therefrom and to which one end of the strap is attached, and wherein said looping means are arranged between the guide means and the attachment point in such a way that the strap, passing from the attachment point to the guide means, may be adjusted in effective length by being passed over different looping means.

22. A mask as claimed in any one of claims 17 to 21 wherein the looping means each comprise an open hook into which the strap can be looped.
